(19) United States
(12) Patent Application Publication
(10) Pub. No.: US 2011/0005463 A1
(43) Pub. Date: Jan. 13, 2011

(54) Absorbent pet pad

(76) Inventor: Chen Lisong, Beizhuang (CN)

Correspondence Address: Edward G. Greive;Renner, Kenner, Greive, Bobak,Taylor & Weber, Fourth Floor, First National Tower, Akron, OH, 44308-1456, US

(21) Appl. No.: 12/459,821

(22) Filed: Jul. 8, 2009

(51) Int. Cl. A01K 29/00

(52) U.S. Cl. 119/171

(57) ABSTRACT

An absorbent pad (10) for use with pets includes a liquid impermeable bottom layer (12), an ink layer (14), and a top layer (22). The pad (10) also includes at least one absorbent layer such as an absorbent fluff layer (18), or an optional first web layer (16), and an optional second web layer (20).

### TECHNICAL FIELD

This invention relates to an absorbent pad for use with pets, wherein the pad includes a water soluble ink and visually indicates when it is wet.

### BACKGROUND ART

A number of devices exist that can absorb moisture, including pads that can absorb moisture when a pet urinates. These include super absorbent puppy pads that can be used during housetraining. However, wetness can often be difficult to determine from a visual inspection of the pad.

Thus, the need exists for a pad that visually indicates when it is wet.

### DISCLOSURE OF THE INVENTION

It is thus an object of the present invention to provide a pad which will indicate when it has been exposed to moisture.

It is another object of the present invention to provide a method for indicating that an absorbent pet pad has been exposed to urine or other liquid.

These and other objects of the present invention, as well as the advantages thereof over existing prior art forms, which will become apparent from the description to follow, are accomplished by the improvements hereinafter described and claimed.

An absorbent pet pad made in accordance with the present invention indicates exposure to moisture, and thus may be said to have a dry state and a wet state. In general, an absorbent pet pad made in accordance with one aspect of the present invention includes a liquid impermeable bottom layer, a water soluble ink layer, at least one absorbent layer; and a top layer, wherein said absorbent layer, top layer, and any optional layers are each sufficiently translucent or become sufficiently translucent upon exposure to moisture that the visual change produced by said ink layer upon exposure to a water-based liquid can be seen by an observer looking down at the pet pad from above said top layer.

A preferred exemplary pet pad made in accordance with the concepts of the present invention is shown by way of example in the accompanying drawing without attempting to show all the various forms and modifications in which the invention might be embodied, the invention being measured by the appended claims and not by the details of the specification.

### BRIEF DESCRIPTION OF THE DRAWINGS

FIG. 1 is a schematic view of an absorbent pad made in accordance with the present invention.

FIG. 2 is a photograph of a dry absorbent pad made in accordance with the present invention.

FIG. 3 is a photograph of the absorbent pad of FIG. 2, after is has been exposed to liquid.

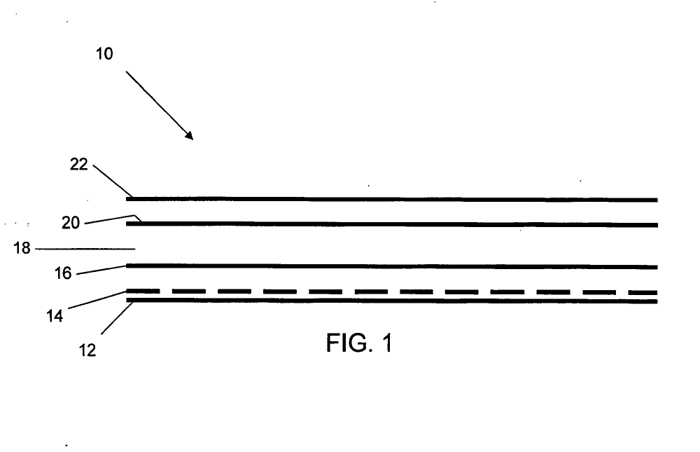

### PREFERRED EMBODIMENT FOR CARRYING OUT THE INVENTION

An exemplary absorbent pad for use with pets is indicated generally by the numeral 10. Pad 10 includes a bottom layer, generally indicated by the numeral 12, an ink layer, generally indicated by the numeral 14, and a top layer, generally indicated by the numeral 22. Pad 10 also includes at least one absorbent layer such as an absorbent fluff layer, generally indicated by the numeral 18, and/or an optional first web layer, generally indicated by the numeral 16, and an optional second web layer, generally indicated by the numeral 20.

Bottom layer 12 is preferably liquid impermeable. “Liquid impermeable,” when used in describing a layer or multi-layer laminate, means that liquid body waste, such as urine, will not pass through the layer or laminate, under ordinary use conditions, in a direction generally perpendicular to the plane of the layer or laminate at the point of liquid contact. It will be understood that the liquid impermeable bottom layer 12 is positioned in direct contact with and functions to protect the surface upon which the pet pad is placed. In some embodiments, the bottom layer also provides strength and structure to the pet pad. In other embodiments, bottom layer 12 may comprise a liquid impermeable film layer that is applied to a substrate layer. In these embodiments, the substrate layer may provide strength and structure to the pet pad, while the film layer functions to provide impermeability. Bottom layer 12 may comprise a thermoplastic polymer such as polyethylene. Other liquid impermeable materials are also suitable.

Ink layer 14 comprises a water soluble ink that produces a visual change upon exposure to a water-based liquid. In the dry state, ink layer 14 may not be visible to an observer looking down upon pad 10 from above top layer 22. When exposed to a water-based liquid, the ink may dissolve and migrate upward into the absorbent layer, whereupon the ink becomes visible to an observer looking down upon pad 10 from above top layer 22. Alternately, ink layer 14 may be visible in both the dry and wet states, but may change appearance. For example, when exposed to water-based liquid, the ink may dissolve and migrate laterally, forming a different visual pattern than that of the dry state.

Water-based liquids include pet urine. The colors of the ink are not limited. The water soluble ink may contain one or more of various pigments that may be dispersed or dissolved in an aqueous or alcoholic solvent. In one or more embodiments, the solvent comprises water, a C₁₋₁₀ alcohol, or a mixture thereof. The ink may include an releasant or other agent such as titanium white or calcium carbonate. Generally, the ink comprises an acidic, basic or direct dye, prepared by mixing one or more pigments with a water-soluble or dispersible binder. Binders include milk casein, bean casein, dextrin, soluble starch, glue, sodium alginate, gum arabic, tragacanth gum, gelatine, polyvinyl alcohols, acrylate resins, and combinations thereof. The dye may be diluted with an aqueous or alcoholic solvent. If necessary, the ink may be mixed with water soluble additives to provide adequate viscosity.

Examples of pigments include china clay, rubber powder, calcium carbonate, mica, ultramarine, cadmium yellow, red iron oxide, chrome yellow, lead white, titanium white, carbon black, and organic pigments such as azo-triphenylmethane, quinoline-, anthraquinone-, and flavocyanine-series pigments.

Specific examples of suitable inks include Xinchi™, available from Zengcheng Huachi Chemical Industry Co., Ltd. In one or more embodiments, the water soluble ink comprises the ingredients shown in Table 1.

TABLE 1

| Chemical name | Percent by weight |
|---|---|
| Acrylate resin | 15-17% |
| Pigment | 10-13% |
| Ethyl alcohol | 10-15% |
| Water | balance |

In one or more embodiments, ink layer 14 may be printed or otherwise adhered to bottom layer 12. In these situations, ink layer 14 may be generally located between bottom layer 12 and first web layer 16. In some embodiments, ink layer 14 is substantially continuous, i.e., covers more than one-half of the area defined by pet pad 10. When a portion of pad 10 is exposed to water-based liquid, it may be possible to visually determine which portion of pad 10 remains dry, i.e., the ink layer 14 will remain unchanged in the area that has not been exposed to water-based liquid.

In other embodiments, ink layer 14 is not a continuous layer, but is applied in a pattern. For example, ink layer 14 may be applied in a pattern that forms a word, such as “wet.”

In other embodiments, ink layer 14 may be printed or otherwise adhered to one or more web layers or to top layer 22. Alternately, ink layer 14 may be co-mingled with fluff layer 18. That is, ink layer 14 may comprise a solid material such as powder or crystals that may be physically mixed with a superabsorbent polymer or other absorbent material to form a fluff layer 18 that has solid particles (ink layer 14) distributed throughout.

As previously described, the absorbent pad of the present invention includes at least one absorbent layer. By absorbent layer is meant a layer that functions to absorb water-based liquid. In certain embodiments, the absorbent layer may comprise one or more plies of tissue, wood pulp, superabsorbent polymer, or the like. In these or other embodiments, more than one absorbent layer may be present. In one or more embodiments, at least one absorbent layer can be fluff layer 18.

Fluff layer 18 may include a superabsorbent polymer or other absorbent material. As used herein, the term “superabsorbent” refers to a special group of polymers that have the ability to absorb many times their own mass of liquid. Super absorbents are configured to swell very rapidly in liquid, but not dissolve. The superabsorbent polymer may be made from the polymerization of acrylic acid blended with sodium hydroxide in the presence of an initiator to form a poly-acrylic acid, sodium salt (sometimes referred to as cross-linked sodium polyacrylate). Other materials may also be used to make a superabsorbent polymer, such as polyacrylamide copolymer, ethylene maleic anhydride copolymer, cross-linked carboxy-methyl-cellulose, polyvinyl alcohol copolymers, cross-linked polyethylene oxide, and starch grafted copolymer of polyacrylonitrile to name a few. Other absorbent materials such as wood pulp may be alone or in conjunction with a super absorbent polymer.

Fluff layer 18 may be opaque in the dry state, such that an observer looking down at pet pad 10 from above top layer 22 cannot see the layers that lie below fluff layer 18. Fluff layer 18 may be sufficiently translucent in the wet state such that the change produced by ink layer 14 upon exposure to liquid can be seen by an observer looking down at pet pad 10 from above top layer 22.

Fluff layer 18 is generally located between bottom layer 12 and top layer 22, but it will be understood that other layers may also be present as intermediate elements, and therefore fluff layer 18 may or may not be in direct contact with the bottom and top layers. In one or more embodiments, fluff layer 18 may be bonded or otherwise connected to first web layer 16 and second web layer 20. Alternately, fluff layer 18 may be bonded or otherwise connected to ink layer 14 and top layer 22.

First web layer 16 is optional. When present, first web layer 16 preferably includes a low porosity cellulosic web, such as tissue paper. In one or more embodiments, web layer 16 includes one or more plies of tissue. Low porosity tissue is further described in U.S. Pat. Nos. 3,837,996 and 4,522,863, both of which are hereby incorporated by reference.

Web layer 16 may provide some liquid absorbency, and may contribute to the strength and structure of the pet pad. First web layer 16 may be bonded or otherwise connected to ink layer 14 and fluff layer 18. First web layer 16 may be opaque in the dry state, such that an observer looking down at pet pad 10 from above top layer 22 cannot see the layers that lie below first web layer 16. First web layer 16 may be sufficiently translucent in the wet state such that the change produced by ink layer 14 upon exposure to liquid can be seen by an observer looking down at pet pad 10 from above top layer 22.

Similar to first web layer 16, second web layer 20 is also optional, and preferably includes a low porosity cellulosic web, such as tissue paper. In one or more embodiments, web layer 20 includes one or more plies of tissue. Web layer 20 may provide some liquid absorbency, and may contribute to the strength and structure of the pet pad. Second web layer 20 may be bonded or otherwise connected to fluff layer 18 and top layer 22. Second web layer 20 may be opaque in the dry state, such that an observer looking down at pet pad 10 from above top layer 22 cannot see the layers that lie below second web layer 20. Second web layer 20 may be sufficiently translucent in the wet state such that the change produced by ink layer 14 upon exposure to liquid can be seen by an observer looking down at pet pad 10 from above top layer 22.

Top layer 22 is preferably a moisture permeable layer. Top layer 22 is sufficiently translucent such that the change produced by ink layer 14 upon exposure to liquid can be seen by an observer looking down at pet pad 10 from above top layer 22. In one or more embodiments, top layer 22 comprises a nonwoven fabric. As used herein, the term “nonwoven” material means a web having a structure of individual fibers or threads which are interlaid, but not in an identifiable manner as in a knitted fabric. Nonwoven fabrics or webs have been formed from many processes such as for example, meltblowing processes, spunbonding processes, and bonded carded web processes. Examples of suitable nonwoven fabrics include polyolefins such as polyethylene, high density polyethylene, low density polyethylene, polypropylene, polyester, nylon, and blends thereof, including bicomponent fibers.

As previously described, each layer of pet pad 10 may be bonded to other layers. “Bonded” refers to the joining, adhering, connecting, attaching, or the like, of two elements. Two elements will be considered to be bonded together when they are bonded directly to one another or indirectly to one another, such as when each is directly bonded to intermediate elements. Layers may be bonded at the edges of pet pad 10, and may additionally be bonded at one or more points within the area defined by pet pad 10.

The absorbent pad can be joined according to various high speed assembly techniques including traditional needle and thread sewing, ultrasonic sealing, heat sealing, such as quilting with heat and pressure, hot-air welding, impulse welding, and radio-frequency welding. In one or more embodiments, hot-melt adhesive may be employed.

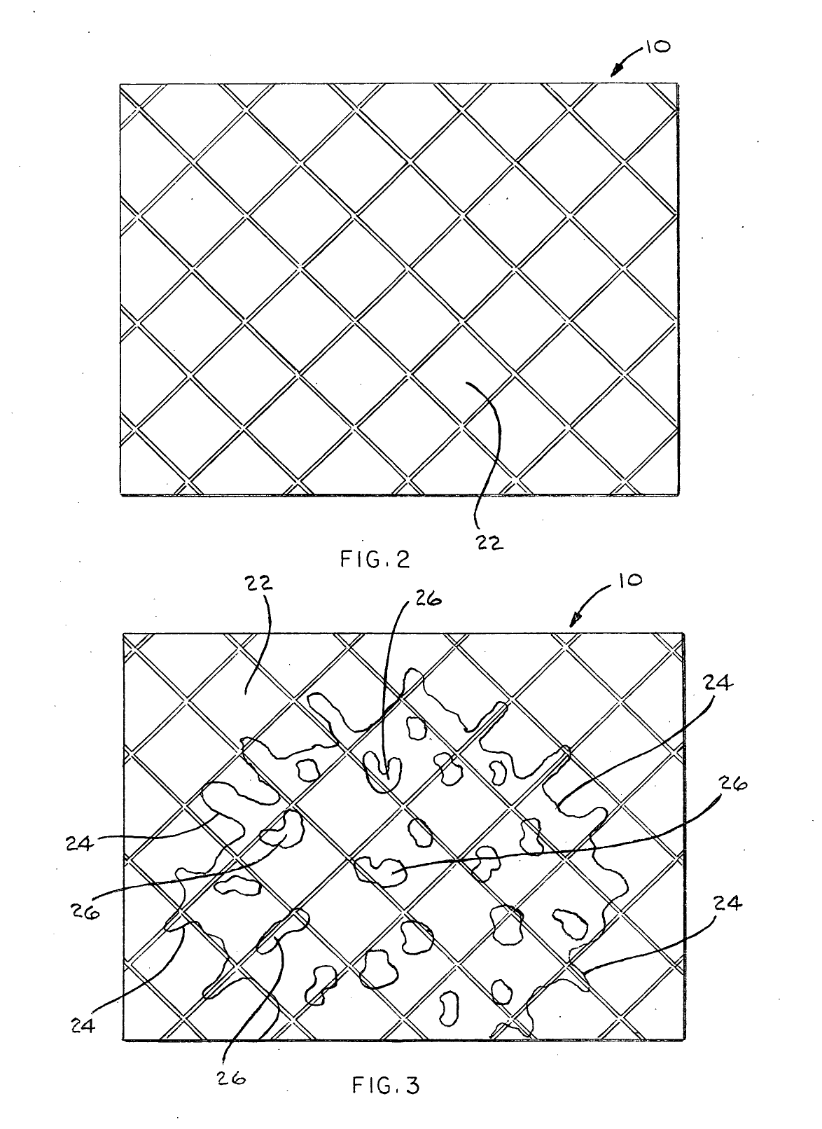

Advantageously, when moisture such as a water-based liquid is applied to the absorbent pad, moisture wicks down through the top permeable layer. A portion of the moisture may come into contact with the layer of water soluble ink. The moisture dissolves the ink and produces an observable, i.e., visual change. The visual change may be a migration of the ink into the absorbent layer(s) or may be a lateral movement of the ink. Each of the layers of pet pad 10, with the exception of bottom layer 12, is sufficiently translucent in the wet state such that the change produced by ink layer 14 upon exposure to a water-based liquid can be seen by an observer looking down at pet pad 10 from above top layer 22. This is shown in the photographs of FIG. 2, which exemplifies a pad in the dry state, and FIG. 3, which exemplifies the same pad in the wet state. Both photographs are taken from the position of an observer looking down at pet pad 10 from above top layer 22. Ink layer 14, which lies below the absorbent layer(s) is not visible in FIG. 2. In FIG. 3, the absorbent layer(s) have become translucent, and the ink has become visible. Some of the ink spots have migrated upward into the absorbent layer(s) and some of the ink spots have spread laterally.

Thus, the present invention provides an absorbent pad that indicates when it has been exposed to urine or other water-based liquid. Upon exposure to liquid, the pad absorbs the liquid, the liquid causes the ink to become observable or to change in a manner that is observable through the top layer and any additional layers that may be between the ink layer and the observer. The bottom layer is not necessarily translucent, and therefore the change of the ink layer may not be readily observed through the bottom layer.

In view of the foregoing, it should be evident that a pad constructed as described herein accomplishes the objects of the present invention and otherwise substantially improves the art.

What is claimed is:

1. An absorbent pet pad having a dry state and a wet state, said pad comprising a liquid impermeable bottom layer, a water soluble ink layer that dissolves and migrates upon exposure to water-based liquid; at least one absorbent layer; and a top layer; wherein said absorbent layer and top layer are each sufficiently translucent in the wet state such that the migration of said ink layer upon exposure to a water-based liquid can be seen by an observer looking down at the pet pad from above said top layer.

2. The pad of claim 1, wherein said absorbent layer comprises a fluff layer.

3. The pad of claim 2, wherein said fluff layer comprises a superabsorbent polymer.

4. The pad of claim 2, wherein said fluff layer comprises wood pulp.

5. The pad of claim 1, wherein said bottom layer comprises a thermoplastic polymer.

6. The pad of claim 1, wherein said bottom layer comprises polyethylene.

7. The pad of claim 1, wherein said water soluble ink layer comprises one or more pigments dispersed or dissolved in an aqueous or alcoholic solvent.

8. The pad of claim 1, wherein said water soluble ink layer comprises from about 15 to about 17 wt. % acrylate resin, from about 10 to about 13 wt. % pigment, from about 10 to about 13 wt. % ethyl alcohol, and water.

9. The pad of claim 1, wherein said top layer comprises a moisture permeable layer.

10. The pad of claim 1, wherein said top layer comprises a nonwoven fabric that includes polyethylene, high density polyethylene, low density polyethylene, polypropylene, polyester, nylon, or a blend thereof.

11. The pad of claim 1, further comprising one or more web layers.

12. The pad of claim 11, wherein said pad comprises a first web layer adjacent to said ink layer and said absorbent layer.

13. The pad of claim 12, wherein said pad further comprises a second web layer adjacent to said absorbent layer and said top layer.

14. The pad of claim 1, wherein said bottom layer is not translucent.

15. A method for making an absorbent pet pad capable of indicating that it has been exposed to urine or other water-based liquid, the method comprising the steps of providing a bottom layer, a water soluble ink layer that produces a visual change upon exposure to water-based liquid, at least one absorbent layer, and a top layer, and bonding the absorbent and ink layers in between the bottom layer and top layer.

16. The method of claim 15, wherein said water soluble ink layer forms a substantially continuous layer and is adjacent to said bottom layer and said at least one absorbent layer.

17. The method of claim 15, wherein said bottom layer is not translucent.

18. The method of claim 15, wherein said top layer comprises a nonwoven fabric that includes polyethylene, high density polyethylene, low density polyethylene, polypropylene, polyester, nylon, or a blend thereof.

19. The method of claim 15, wherein said at least one absorbent layer comprises a fluff layer.

20. The method of claim 15, wherein said fluff layer comprises a super absorbent polymer.
